(19) United States
(12) Patent Application Publication
(10) Pub. No.: US 2018/0213726 A1
(43) Pub. Date: Aug. 2, 2018

(54) PLANT VESSEL AND METHOD FOR PRODUCING A PLANT VESSEL

(71) Applicant: PRETTY EASY B.V., Westland (NL)

(72) Inventors: THEO GRUENEWALD, LUENEN (DE); JAN GRUENEWALD, SELM (DE)

(73) Assignee: PRETTY EASY B.V., Westland (NL)

(21) Appl. No.: 15/927,194

(22) Filed: Mar. 21, 2018

Related U.S. Application Data
(63) Continuation of application No. 14/378,438, filed on Aug. 13, 2014, now abandoned.

(30) Foreign Application Priority Data
Feb. 6, 2012 (DE) 102012101263.6
Mar. 22, 2012 (DE) 202012101025.9
Apr. 3, 2012 (DE) 202012101204.9

(51) Int. Cl. A01G 9/02

(52) U.S. Cl. CPC A01G 9/02

(57) ABSTRACT

A ready-to-sell unplanted plant vessel includes an accommodation space in which an amount of substrate sufficient for planting at least one plant in the vessel is arranged. The plant vessel offers improved protection against spilling of the contained substrate and is simple and cost-effective to produce. A foil-like cover is fastened to the plant vessel and covers the accommodation space so that the substrate is prevented from exiting the accommodation space.

### CROSS REFERENCE TO RELATED APPLICATIONS

This application is a continuation of, and claims the benefit of, U.S. patent application Ser. No. 14/378,438, filed on Aug. 13, 2014, which is entitled to the benefit of and incorporates by reference essential subject matter disclosed in International Application No. PCT/EP2013/053025 filed on Feb. 14, 2013, German Patent Application No. 102012101263.6 filed on Feb. 16, 2012, German Patent Application No. 202012101025.9 filed on Mar. 22, 2012, and German Patent Application No. 202012101204.9 filed on Apr. 3, 2012, all of the foregoing being hereby incorporated by reference herein in their entireties.

### FIELD OF THE INVENTION

The present invention relates to a ready-to-sell, unplanted plant vessel, which has an accommodation space in which an amount of substrate sufficient for planting at least one plant is arranged. The invention also relates to a method for producing such a plant vessel.

### BACKGROUND OF THE INVENTION

Plant vessels in which ornamental or useful plants can be planted are known in a multiplicity of shapes and designs in the prior art. In particular end users require such plant vessels to install plants, in particular ornamental plants or herbs, in houses, apartments, gardens or on balconies. The plant vessels are generally offered for sale empty. A user wishing to install a plant therefore usually buys such an empty plant vessel and additionally and separately substrate for placing in the plant vessel and for embedding the plant. The substrate is often offered for sale in relatively large packages (e.g. in 5 L, 10 L, 20 L or 25 L sacks), in any case in packages whose contents do not correspond to the size of certain plant vessels. As a result, a user who has placed in the plant vessel the amount of substrate necessary for planting the plant in the plant vessel generally has an excess of substrate left over. This is then either discarded unused or leads to storage problems, in particular in private households. Furthermore, substrate is often scattered during the filling process, which entails inconvenient cleaning for the user.

Accordingly, it can be advantageous to offer for sale to the end user a plant vessel into which substrate has already been placed. The occurrence of excess substrate and scattering of the substrate during the filling process can be avoided thereby. The substrate is provided in the plant vessel in such an amount that one or more plants can be planted in the plant vessel, depending on the intended use.

It is known from DE 1 913 884 U to use a flat tray consisting of hard plastic as the lid for flowerpots that are already filled with earth at the time of sale, in order to prevent the contained earth from spilling unintentionally. Alternatively to the lid, the provision of a cardboard disc is proposed, which is introduced from above into the accommodation space of the flowerpot and pressed in there. This cardboard disc pressed into the flowerpot is then intended to act as protection against spilling of the contained earth.

### SUMMARY OF THE INVENTION

The invention is then based on the object of providing a ready-to-sell, unplanted plant vessel filled with substrate, which offers improved protection against spilling of the contained substrate and further improves the production of the plant vessel in terms of effort and cost. This object is achieved with a plant vessel having the features of claim 1 and a method for producing such a plant vessel having the features of claim 14.

The invention includes providing a foil-like cover to cover the accommodation space. This foil-like cover is also fastened to the plant vessel, i.e. attached fixedly to the latter. The fixed attachment of the foil-like cover to the plant vessel means that spilling of the substrate caused during transport or by inadvertent tipping of the plant vessel is reliably prevented. In contrast to, for example, a cardboard disc that is merely pushed into a flowerpot, the fastened foil-like cover cannot unintentionally slip or fall out of the plant vessel. The foil-like cover can be fastened to the plant vessel in principle in any desired manner. It is only essential that the connection between the plant vessel and the foil-like cover is permanent and the cohesion between the two components is great enough to prevent inadvertent or else handling-induced detachment of the foil-like cover. At the same time, the cohesion should only be so strong that the end user can detach or remove the foil-like cover or a predefined section of the same from the plant vessel without great effort in order to be able to plant a plant in the plant vessel.

The production of the cover from a foil-like material has the further advantage that the cover can be produced and fastened to the plant vessel in a particularly simple and cost-effective manner. This is attributable to the widespread use of foil-like materials and also to their flexibility. The foil-like material for producing a cover can in principle comprise all known foil types. The term “foil” means all materials that comprise a relatively thin sheet or a thin layer that has a certain flexibility. In particular, foils can generally be rolled up. Foils can for example be thinner than 3 mm, preferably thinner than 1 mm, particularly preferably thinner than 0.5 mm. The term “foil-like cover” then means in the present connection all such covers or materials that have foil-like properties.

In particular, the flexibility of the foil-like cover is advantageous for the production of the ready-to-sell plant vessels. For instance, thanks to this material property the fastening of the foil-like cover to the plant vessel can take place in many different ways and in an extremely variable manner and be produced simply.

The foil-like cover fastened to the plant vessel effects a closure of the accommodation space of the plant vessel, which is sufficient to prevent the contained substrate from spilling, even if the plant vessel is tipped. The closure effected by the foil-like cover therefore does not necessarily have to be gas- or moisture-tight. Rather, it is expedient to allow a passage of gas or moisture in order to achieve regulation of the humidity in the accommodation space for the time until opening of the cover by the end user. Furthermore, it is possible to make the foil-like cover transparent or opaque depending on the intended use.

The plant vessel generally comprises one or more walls that enclose the accommodation space. Additionally, a plant vessel bottom is often also provided, which forms the lower end of the plant vessel. The plant vessels are normally open at the top to receive the substrate and the plants. The plant vessel according to the invention can be designed for use alone or else for placing into planters or the like.

The term “substrate” in the present connection means any fertile soil into which plants can be planted. This can be for example grown soil that is characterised by its respective soil type, earth with additives, compost, granules, peat etc. Furthermore, the substrate can comprise any type of additives or auxiliary materials, such as bark, hydrogel polymers, plastics etc. The substrate can be placed either directly into the accommodation space of the plant vessel or into a further vessel, which is then in turn introduced into the accommodating space. The substrate is expediently not packed separately, for example in a bag or the like, but placed loose and directly into the plant vessel or into a further vessel that is introduced into the plant vessel. Planting is thereby made possible without prior transfer of the substrate from any packaging into the plant vessel.

The plant vessel according to the invention is in the ready-to-sell state, i.e. it can be provided for sale. Accordingly, it is also unplanted, i.e. there are no plants introduced or planted into the plant vessel. Nevertheless, it corresponds to the intended use of the plant vessel that it is planted with one or more plants at a time after being sold. To this end, the foil-like cover is then to be removed from the plant vessel beforehand. The plant vessel is preferably dimensioned in such a manner that it can accommodate conventional, fully grown ornamental plants.

In principle, the plant vessel can be any vessel or container for planting plants that is known from the prior art. The plant vessel is preferably a balcony or flower box, a flowerpot, a plant tub or else a hanging basket, in either an angular or round design. The plant vessels are generally produced from plastic, but another material selection is also possible. Plant vessels that have intermediate floors for temporary water storage can also be used. Such plant vessels can additionally comprise water level indicators.

The foil-like cover can expediently comprise a plastic foil and/or a metal foil. It can be a purely plastic or metal foil or else a foil that has both plastic and metal portions. Depending on the desired use and type of production and fastening, a respectively suitable plastic and/or metal foil can be used. In particular, PET foil or else so-called “mulch foil” can be used as the plastic foil. Mulch foils can for example be produced on the basis of polyethylene foils. Metal foils can be formed by thin metal sheets, aluminum or tin foil can in particular be used in the present case. Foils having metal portions can also be used, such as are used in conventional yoghurt pots. The foil-like cover can also be designed in such a manner that it can be provided with a printed label, in particular one that provides instructions for planting.

In a further advantageous embodiment, the foil-like cover is compostable. In the present connection this means foil-like covers in which at least some constituents decompose over a certain period to form water, carbon dioxide and humus. Such materials are commonly referred to as “biodegradable”. The compostability of the foil-like cover can in particular be achieved by the use of bioplastics for producing the foil-like cover. Such bioplastics are produced on the basis of renewable raw materials.

The fastening of the foil-like cover to the plant vessel can take place in its simplest form by winding the foil-like cover around the plant vessel. In this case the foil-like cover must be provided in a sufficient length. Fastening can also be achieved using the properties of the foil-like cover itself. This can take place for example with the use of adhesive foil, which can adhere to the smooth outer surface of the plant vessel without additional adhesive. The advantage of these embodiments is that the fastening takes place without additional fastening means and thus production is further simplified. The important thing for any fastening type is that sufficient fixing of the foil-like cover is achieved and the latter is not merely placed loosely on top. To produce sufficient fastening and to ensure that the foil-like cover does not unintentionally slip, it is further expedient that the foil-like cover is not jammed or pressed into the interior of the plant vessel, as is known for example from DE 1913884 U for a cardboard disc as a cover of a flowerpot.

In a preferred embodiment, the foil-like cover is adhesively bonded and/or fused to the plant vessel. The fusing of the foil to the plant vessel can take place in any suitable manner known from the prior art. Likewise, any suitable adhesive known from the prior art can be used for the fastening of the foil-like cover. The selection of the suitable adhesive or the suitable fusing method depends critically on the properties of the foil and also on the material and shape properties of the plant vessel. Heat-seal lacquers, which are also used for sealing yoghurt pots with yoghurt pot foils, are an example of a possible adhesive.

It is further preferred that fastening means such as clips or elastic bands (e.g. rubber bands) are provided for fastening the foil-like cover to the plant vessel. Adhesive or fused seams are likewise considered fastening means in the present connection. With such fastening means, the foil-like cover can be attached securely to the plant vessel in a simple manner, the foil-like cover at the same time being easily removable or detachable for the end user.

The accommodation space of the plant vessels is generally formed by one or more walls of the plant vessel and where necessary a plant vessel bottom. The plant vessels are generally open at the top, so that an upper plant vessel edge is produced, which encloses or delimits, respectively, a receiving opening of the accommodation space, through which plants or else substrate can be introduced into the accommodation space. In a preferred embodiment, the foil-like cover is fastened to the said upper edge of the plant vessel, in particular by means of adhesive bonding or fusing. Additionally or alternatively, the fastening can also take place to an outer wall or bottom face of the plant vessel, i.e. to the outer side of the plant vessel walls or of the plant vessel bottom. In particular, it is further preferred for the fastening not to take place in the interior of the accommodation space, i.e. for the foil-like cover not to be fastened to the inside of the plant vessel walls or of the plant vessel bottom. This ensures that the attachment of the foil-like cover to the plant vessel can take place in a simple and cost-effective manner. It is also relatively easy for the user to remove a foil-like cover fastened in this manner.

It is further advantageous to provide a fastening flange on the upper edge, on which the foil-like cover is fixedly arranged. The flange can advantageously project outwards from the plant vessel, but an inner arrangement is also possible in principle. For example, the flange can act as an adhesive and/or fusing face. In this case, a flat, outwardly projecting flange is preferably to be used. The foil-like cover can also be wrapped around the flange and thus tightened thereon. With this type of fastening, a flat or curved, outwardly projecting flange is preferably to be used.

In a further preferred embodiment, means for removing the foil-like cover are provided in order to make it easier for the end user to remove the foil-like cover before planting the plant. Also, the risk of the foil-like cover tearing or being damaged during removal and some of the foil-like cover remaining on the plant vessel as a result is reduced thereby. An example of such a means for removal that is attached to or introduced into a foil-like cover is a tear-open strip. This can be attached to the foil-like cover at the same place as the fastening or else spatially separate therefrom. It is in particular expedient to provide these means for removal on the foil-like cover itself.

The means for removing the foil-like cover further expediently comprise a grip for making handling easier for the user. To simplify production of the grip, it is particularly preferred for the latter not to be produced from a separate material and then have to be attached to the foil-like cover, but to be formed directly from the material of the foil-like cover itself. This can take place for example by the formation of a tab or tongue on the foil-like cover. In a particularly simple embodiment, the grip can be produced by making the dimensions of the foil-like cover oversized in relation to the opening of the accommodation space of the plant vessel so that it projects over the upper edge (on which the foil-like cover is fastened to the plant vessel). This projection of the foil-like cover then forms the grip. The tear-open strip mentioned above by way of example can also have such a grip in the form of a free strip end.

In a further preferred embodiment, the foil-like cover is configures as gas- or air-permeable and/or moisture-permeable. This allows exchange of the air or moisture, respectively, in the accommodation space with the external air and prevents an undesirable formation or buildup of fermentation gas or the like in the accommodation space. Ventilation of the accommodation space is made possible at any time by the preferred configuration of the foil-like cover.

To ensure gas permeability, an air- or gas-permeable foil and/or a moisture-permeable foil can for example be used to form the foil-like cover. Alternatively or additionally, it is possible to provide passages or holes, in particular in the form of perforations, in the foil-like cover.

In a further preferred embodiment, it is provided for the foil-like cover not to be removed completely from the plant vessel, but for the means for removing the foil-like cover to be formed in such a manner that only a predefined section of the cover is removed, so that for example some of the cover remains along the edge of the plant vessel. In particular when planted with plants that have a high water requirement, this edge can prevent water splashing out of the plant vessel during watering. In the present embodiment, the means for removal can advantageously be formed as a perforated section or as a tear-open strip.

The object on which the invention is based is also achieved by means of a method for producing a ready-to-sell, unplanted plant vessel that is filled with substrate and covered, which method comprises the following steps:
a. provision of a plant vessel comprising an accommodation space,
b. filling of the accommodation space with substrate in an amount sufficient for planting at least one plant in the plant vessel,
c. provision of a foil-like cover, and
d. fastening the foil-like cover to the plant vessel to cover the accommodation space.

If the foil-like cover is gas-impermeable or does not allow sufficient gas or air exchange, it is expedient to make passages, in particular perforations, in the foil-like cover in an additional step.

### BRIEF DESCRIPTION OF THE DRAWINGS

The invention is further explained below using exemplary embodiments shown in the drawing. In the figures,

FIG. 1 schematically shows a plant vessel that has already been filled with substrate but has not yet been covered;

FIG. 2 schematically shows the plant vessel of FIG. 1 with a foil-like cover fastened to the plant vessel, having a tear-open tab;

FIG. 3 schematically shows the plant vessel of FIG. 1 with a foil-like cover fastened to the plant vessel, having a tear-open strip; and

FIG. 4 schematically shows the plant vessel of FIG. 1 with a foil-like cover fastened to the plant vessel, having perforations to detach part of the foil-like cover.

### DETAILED DESCRIPTION OF THE PREFERRED EMBODIMENT

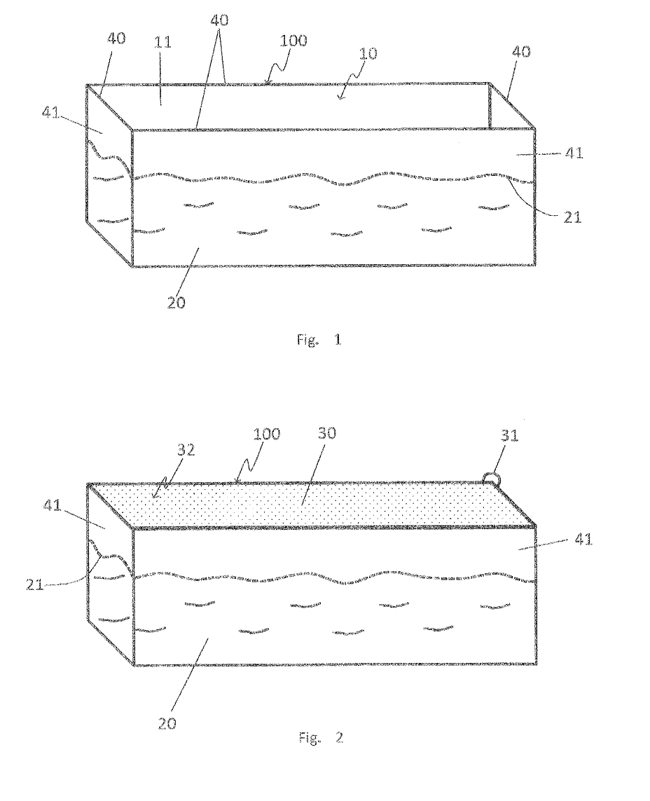

FIG. 1 shows a box-shaped plant vessel 100, which has an approximately cuboid shape. The plant vessel 100 comprises four side walls 41 and a bottom (not shown). The plant vessel 100 is open at the top. The plant vessel walls 41 have a uniform height and therefore terminate at an upper edge 40 that runs all the way round. The upper edge 40 encloses and delimits a receiving opening 11. A substrate 20 is introduced into the inner accommodation space 10 of the plant vessel 100 through the receiving opening 11. The accommodation space 10 is formed by the inner faces of the side walls 41 of the plant vessel 100 and the inner face of the bottom.

The substrate 20 is introduced into the accommodation space 10 up to a substrate line 21 shown with dashed lines. The substrate line 21 is intended to indicate the surface of the contained substrate mass schematically and is only shown for the sake of clarity.

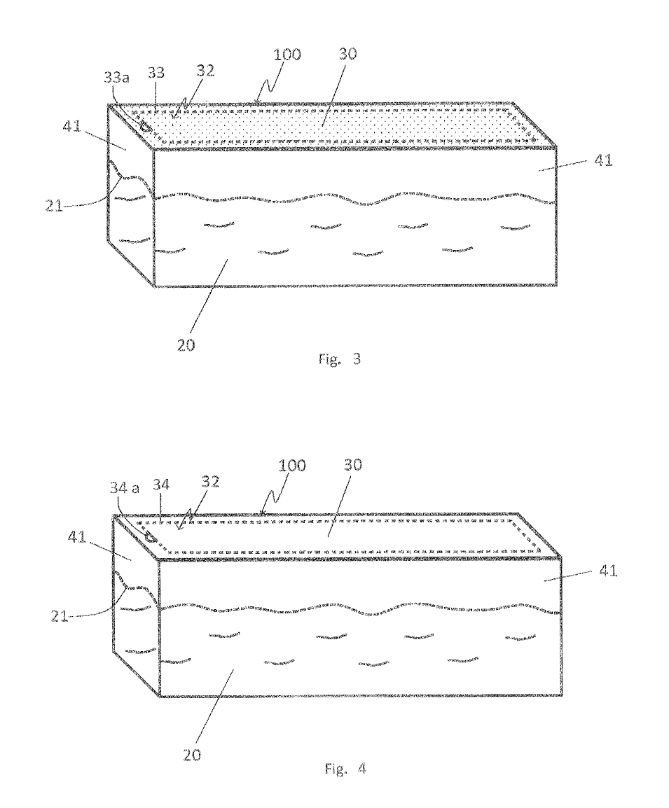

In the non-inventive plant vessel 100 shown in FIG. 1, the receiving opening 11 is not closed, so the substrate 20 arranged in the accommodation space 10 would spill out of the plant vessel 100 as a result of lateral tipping of the plant vessel 100 or the like. In the diagram of FIG. 2, however, the receiving opening 11 of the plant vessel of FIG. 1 is according to the invention covered and closed with a foil-like cover 30, so the substrate 20 is prevented from spilling out of the plant vessel 100. The foil-like cover 30 is dimensioned to fit the receiving opening 11 exactly, so its edge regions come to bear on the upper edge 40 of the plant vessel 100. The foil-like cover 30 is also adhesively bonded to the plant vessel 100 on the upper edge 40 and therefore attached fixedly to the plant vessel 100. The foil-like cover 30 has a projecting tab 31 in one corner. This tab 31 can be used by a user to remove the foil-like cover 30 from the plant vessel 40 by simply pulling down and thereby to open the receiving opening 10 in order to introduce and plant a plant. A perforated portion 32 is made in the foil-like cover 30, which is formed by a multiplicity of indicated holes. The perforations 32 are distributed over the entire area of the foil-like cover 30.

The plant vessel 100 shown in FIG. 3 is for the most part identical to the plant vessel 100 of FIG. 2. The only difference consists in that the foil-like cover 30 in FIG. 3 has no tear-open tab 31, but rather a tear-open strip 33 is made in the foil-like cover instead. The tear-open strip 33 runs in the form of a closed rectangle, the individual sides of the rectangle each running parallel to and equidistant from the upper edge 40. The tear-open strip 33 has a projecting grip 33a, by means of which a user can remove the tear-open strip from the foil 33 and thereby detach the region of the foil-like cover 30 that is enclosed by the tear-open strip 33 from the plant vessel. The region of the foil-like cover 30 between the tear-open strip 33 and the upper edge 40 remains fastened to the plant vessel 100 and can for example act as splash protection when plants (not shown) planted in the plant vessel 100 are watered.

The plant vessel 100 shown in FIG. 4 is for the most part identical to the plant vessel 100 of FIG. 3, but no tear-open strip is made in the foil-like cover. Perforations distributed over the entire foil are likewise not provided, but rather a rectangular perforated portion 34 instead, the individual sites of the rectangle each running parallel to and equidistant from the upper edge 40. A grip 34a in the form of a tab is also provided on the part region of the foil-like cover that is enclosed by the perforated rectangle 34. This grip 34a can be used by a user to detach and remove the part region of the foil-like cover 30 that is enclosed by the perforated portion 34. The region of the foil-like cover 30 between the perforated portion 34 and the upper edge 40 remains fastened to the plant vessel 100 and can for example act as splash protection when plants (not shown) planted in the plant vessel 100 are watered. The advantage of this embodiment is that the perforated portion 34 at the same time acts as means for removing a part region of the foil-like cover 30 and as a passage for ventilating the accommodation space 10.

1. A ready-to-sell, unplanted plant vessel, which has an accommodation space, in which an amount of substrate sufficient for planting at least one plant in the plant vessel is arranged,
said plant vessel comprising a foil-like cover, said foil-like cover being fastened to the plant vessel and covering the accommodation space so that the substrate is prevented from exiting the accommodation space and that spilling of the substrate caused during transport or inadvertent tipping of the plant vessel is prevented,
wherein a grip is provided for completely or partially removing the foil-like cover, said grip being formed from the foil-like cover and configured as a tab or a tongue,
wherein the foil-like cover is adhesively bonded to the plant vessel with a heat-seal lacquer,
wherein the foil-like cover is thinner than 0.5 mm,
wherein the substrate is soil.

2. The plant vessel according to claim 1, wherein the plant vessel is a balcony box, a flowerpot, a plant tub or a hanging basket.

3. The plant vessel according to claim 1, wherein the foil-like cover comprises at least one of a plastic foil, in particular PET foil or mulch foil, and a metal foil, in particular aluminum foil.

4. The plant vessel according to claim 2, wherein the foil-like cover comprises at least one of a plastic foil, in particular PET foil or mulch foil, and a metal foil, in particular aluminum foil.

5. The plant vessel according to claim 1, wherein the foil-like cover is compostable.

6. The plant vessel according to claim 1, wherein the foil-like cover is fused to the plant vessel.

7. The plant vessel according to claim 1, wherein fastening means, in particular clips or elastic bands, are provided to fasten the foil-like cover to the plant vessel.

8. The plant vessel according to claim 1, wherein the accommodation space has a receiving opening, which is enclosed by an upper edge of the plant vessel, wherein the foil-like cover is fastened to at least one of the upper edge and an outer wall face or bottom face of the plant vessel.

9. The plant vessel according to claim 8, wherein the upper edge has a flange, which in particular projects outwards, for fastening the foil-like cover.

10. The plant vessel according to claim 1, wherein the means for removing the foil-like cover are attached to the foil-like cover and in particular comprise a tear-open strip.

11. The plant vessel according to claim 1, wherein the foil-like cover is configured as at least one of gas-permeable and moisture-permeable so that it allows exchange of the air or moisture, respectively, in the accommodation space with external air.

12. The plant vessel according to claim 11, wherein the foil-like cover is configured as at least one of a gas-permeable foil and a moisture-permeable foil or that passages, in particular in the form of perforations, are provided in the foil-like cover.

13. The plant vessel according to claim 1, wherein the means for partially removing the foil-like cover are formed in such a manner that after use of the means as intended a part region of the foil-like cover remains on the plant vessel, the means preferably being formed as a tear-open strip or as a perforated portion.

14. A ready-to-sell, unplanted plant vessel, which has an accommodation space, in which an amount of substrate sufficient for planting at least one plant in the plant vessel is arranged,
said plant vessel comprising a foil-like cover being fastened to the plant vessel and covering the accommodation space so that the substrate is prevented from exiting the accommodation space and that spilling of the substrate caused during transport or inadvertent tipping of the plant vessel is prevented,
wherein a grip is provided for completely or partially removing the foil-like cover,
wherein the plant vessel is produced from plastic,
wherein the plant vessel is a balcony box or a flowerpot,
wherein the foil-like cover comprises a PET foil,
wherein the foil-like cover is thinner than 0.5 mm,
wherein the substrate is soil.

15. The plant vessel according to claim 14, wherein the grip is formed from the foil-like cover and preferably is formed as a tab.

16. A ready-to-sell, unplanted plant vessel, which has an accommodation space, in which an amount of substrate sufficient for planting at least one plant in the plant vessel is arranged,
said plant vessel comprising a foil-like cover being fastened to the plant vessel and covering the accommodation space so that the substrate is prevented from exiting the accommodation space and that spilling of the substrate caused during transport or inadvertent tipping of the plant vessel is prevented,
wherein a grip is provided for completely or partially removing the foil-like cover, said grip being formed from the foil-like cover,
wherein the accommodation space has a receiving opening, which is enclosed by an upper edge of the plant vessel,
wherein the foil-like cover is fastened to the upper edge of the plant vessel,
wherein the upper edge has a flange, which projects outwards,
wherein the foil-like cover is fastened to the flange,
wherein the substrate is soil.

17. The plant vessel according to claim 16, wherein the grip is formed as a tab.
